(19) United States
(12) Patent Application Publication
(10) Pub. No.: US 2012/0291639 A1
(43) Pub. Date: Nov. 22, 2012

(54) External Cylinder Packer Head

(76) Inventor: Ryan Thomas Blankenship, Bonney Lake, WA (US)

(21) Appl. No.: 13/108,452

(22) Filed: May 16, 2011

(51) Int. Cl. B30B 1/42

(52) U.S. Cl. 100/214

(57) ABSTRACT

Disclosed is a way of mounting cylinders on the outside of the packer head of a compactor. With this disclosure the cylinders as well as guides may be much easier and faster to change or service resulting in less downtime for the owner and less costly repairs.

### TECHNICAL FIELD

This disclosure pertains to garbage compactors, and, more specifically, to the hydraulic cylinder configuration on garbage compactors.

### BACKGROUND OF INVENTION

Current compactor designs consist of cylinders being mounted inside of a packer head behind a ram. These cylinders are connected to the packer head at one end and the ram on the other. These cylinders force the ram forward compacting garbage into a container. In self-contained machines the cylinders are sometimes mounted in a cross pattern which increases wear of cylinder pins and pin mounts. This makes repairs difficult as the space that the cylinders are mounted in may be very small and cramped. This puts a lot of stress on hoses and cylinders when any material bypasses the ram, which may cause the cylinders to start compacting in reverse as well, which may wear the machine out twice as fast. The bypassed garbage may compact in between hoses causing them to burst, resulting in additional maintenance requirements. It may be very hard to clean out behind the ram with the cylinders in this area because there is even less space with the cylinders in here.

It may also be very difficult to remove the cylinders in this cramped space when they need to be replaced. The pins must normally be cut with a torch resulting in increased health risks with the technician normally being in this space with the smoke of the torch.

Current compactors with guide systems also have the guides bolted to the ram. In order for the guides to be replaced the ram must be removed from the packer head resulting in increased maintenance costs and more down time for the owner of the equipment.

### SUMMARY

In the instant application, cylinders may be mounted to the outside of a charge chamber. This may result in easier maintenance and lower repair bills. In cases where the pins are rusted solid and must be cut out the technician may not be confined to such a cramped space, lowering health risks and allowing faster maintenance resulting in less expensive repairs. There may also be several variations of guide systems removable from the outside of the machine, which may provide similar benefits.

In one embodiment, one end of a cylinder would be connected to a bracket at the back of a packer head on the outside of the packer head. The opposite end of the cylinder would be connected to a bracket on the outside of the charge chamber protruding through a gap in the side of the charge chamber and back to the ram. In another embodiment the bracket protrudes directly through the side of the charge chamber to the ram

### BRIEF DESCRIPTION OF THE DRAWINGS

FIG. 1 is a top view of one embodiment of an entire compactor with external cylinders.

FIG. 2 is an elevation view one embodiment of a ram

FIG. 3 shows one embodiment of a packer head body.

FIG. 4 shows one embodiment of a side of a packer head with a ram inside of a charge chamber without cylinders attached.

FIG. 5 is a top view of one embodiment of a ram.

### DETAILED DESCRIPTION OF THE INVENTION

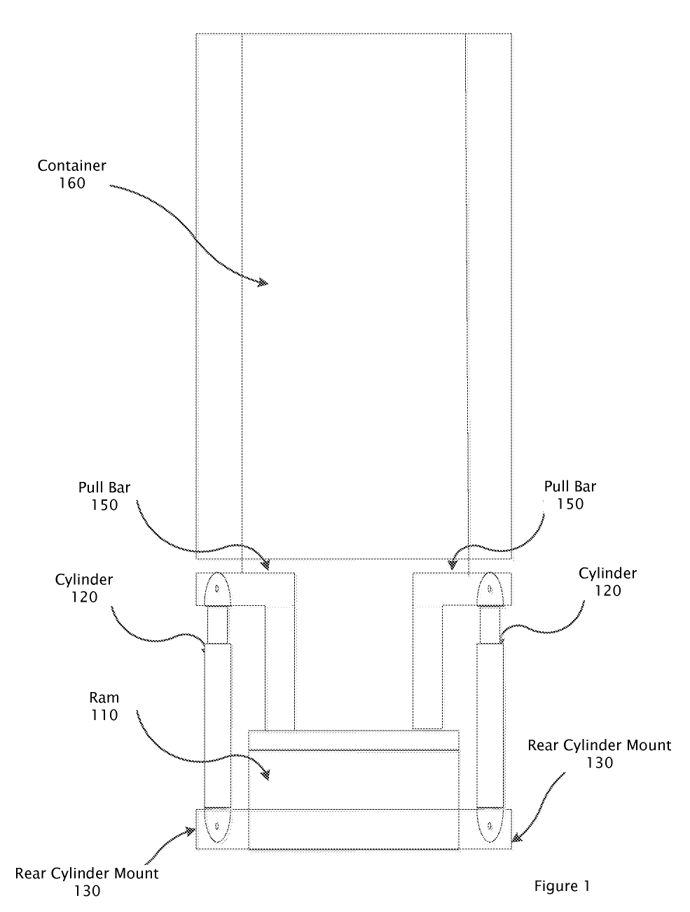

FIG. 1 illustrates one embodiment of a compactor with external cylinders as viewed from the top. In this embodiment, ram (110) pushes garbage into a container (160) and compacts it. Cylinders (120) push one or more pull bars forward away from a back of a packer head. Rear cylinder mount (130) is an attachment point where cylinders (120) connect to the back of the packer head. Pull Bar (150) is connected to the forward end of the cylinders and extends back to the ram through the sides of the charge chamber.

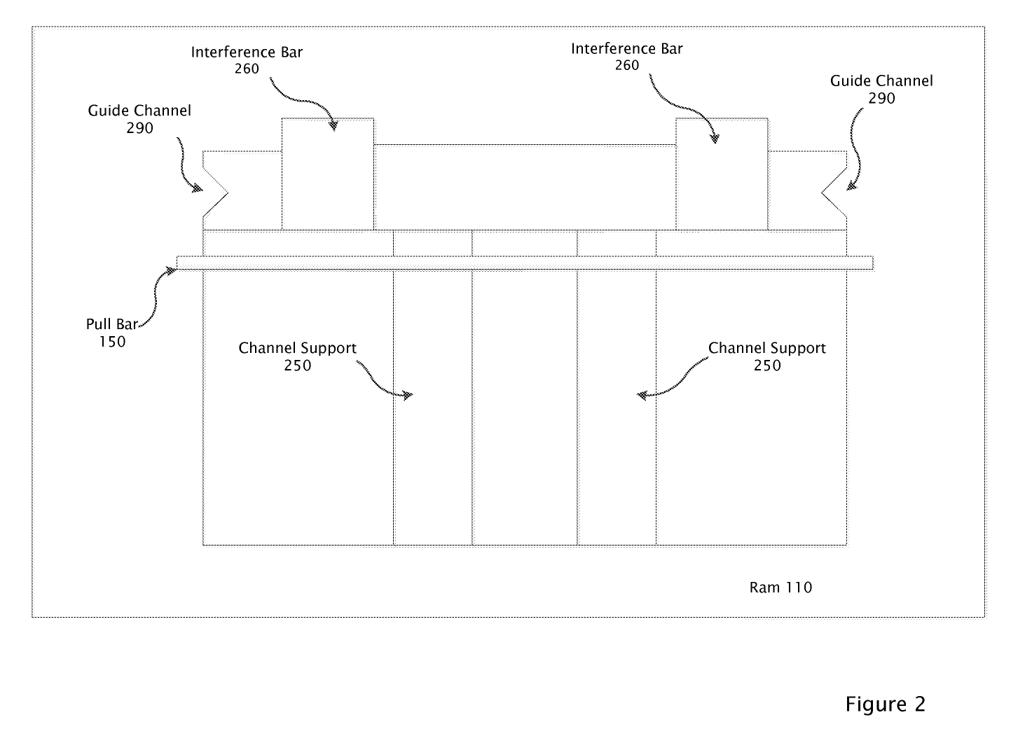

FIG. 2 is a drawing of an elevation view one embodiment of a ram. In this embodiment, ram (110) comprises channel supports (250), which are channel iron and provide strength to the ram (110). Guide channels (290), allow the ram (110) to be guided as it moves, holding it in a proper position and off of the floor to compact garbage. Interference bars (260) pull a follower plate (270) forward.

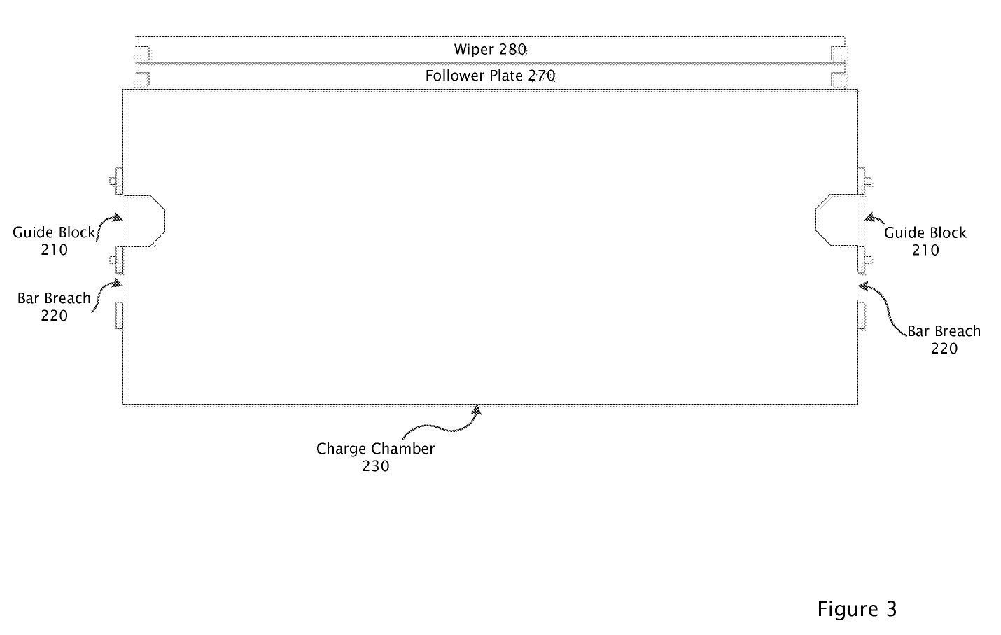

FIG. 3 shows one embodiment of a packer head body. In this embodiment, guide block (210) suspends a ram off of the floor by fitting inside of guide channels (290). Bar breach (220) is a gap where a pull bar (1 50) protrudes through a container (160). A follower plate (270) is pulled forward above and behind the ram (110) to prevent garbage from falling behind the ram (110). A wiper (280) sits above the follower plate (270) and wipes garbage from it. A charge chamber (230) is where the ram (110) is located. The ram (110) moves within the charge chamber to compact garbage in container (160).

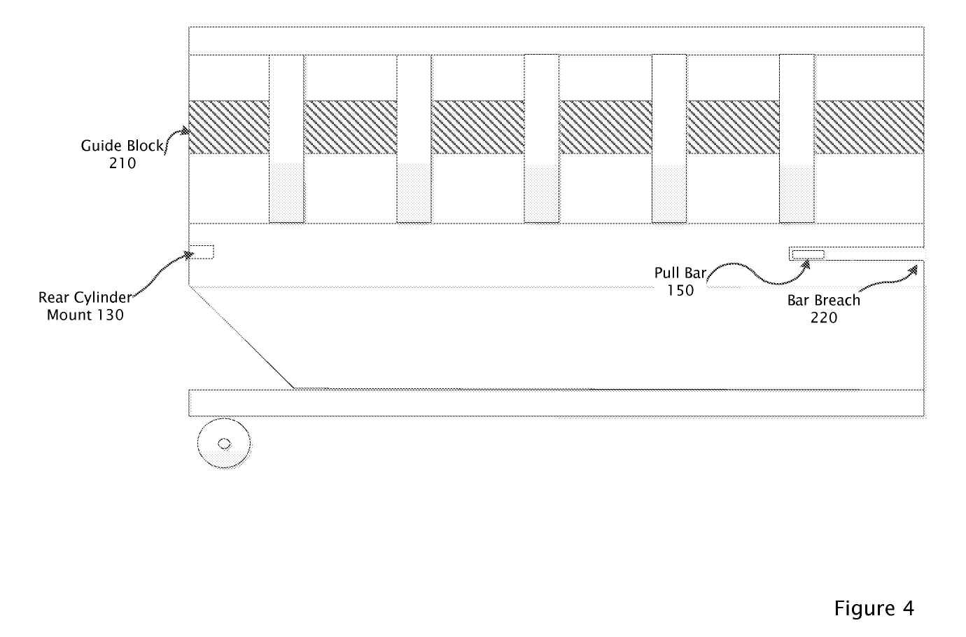

FIG. 4 shows a side view of one embodiment of a packer head with a ram inside of a charge chamber without cylinders attached. Cylinders may be attached to rear cylinder mount (130) and pull bar (150) to move a ram inside the packer head.

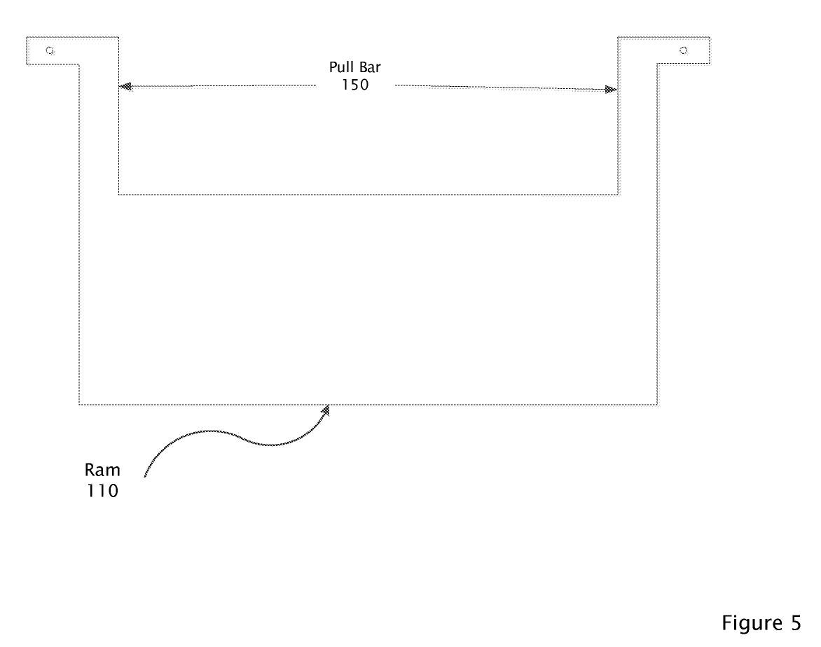

FIG. 5 shows a top view of one embodiment of a ram. Pull bar (150) may be attached to cylinders which push the pull bar (150), which pulls the ram to compact the garbage.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1) A compacting apparatus comprising:
a packing head, comprising an inside, an outside, a front end, a rear end, a left side and a right side;
a rear cylinder mount, attached near the rear end of the packing head on the outside of the packing head;
a ram comprising a pull bar, the pull bar extending from the inside of the packing head to the outside of the packing head near the front end of the packing head; the pull bar further comprising a cylinder mount on a portion of the pull bar which extends from the packing head;
a first cylinder attached to the rear cylinder mount and attached to the pull bar.

2) The compacting apparatus of claim 1 wherein the first cylinder is attached to the rear cylinder mount using a bolt.

3) The compacting apparatus of claim 1 wherein the first cylinder is attached to the pull bar using a bolt.

4) The compacting apparatus of claim 1 wherein the first cylinder is a hydraulic cylinder.

5) The compacting apparatus of claim 1 wherein the first cylinder is attached on the left side of the packing head.

6) The compacting apparatus of claim 1 wherein the first cylinder is attached on the right side of the packing head.

7) The compacting apparatus of claim 1 wherein the first cylinder is attached on the left side of the packing head and a second cylinder is attached to the right side of the packing head.

8) The compacting apparatus of claim 1 wherein the first cylinder is attached to the rear cylinder mount using a pin.

9) The compacting apparatus of claim 1 wherein the first cylinder is attached to the pull bar using a pin.

10) The compacting apparatus of claim 1 wherein the first cylinder is attached to the packing head using a trunnion mount.

11) A compacting apparatus comprising:
a packing head, comprising an inside, an outside, a front end, a rear end, a left side and a right side;
a first guide attached to the packing head and removable from the outside of the packing head;

12) The compacting apparatus of claim 11 wherein the first guide is attached to the outside of the packing head using bolts.

13) The compacting apparatus in claim 11 wherein the first guide is attached to the outside of the packing head using a weld.

14) The compacting apparatus in claim 11 wherein the first guide is attached to the outside of the packing head using retainers.

15) The compacting apparatus in claim 11 wherein the first guide is a strip that can be slid longitudinally into the sides of the packing head.

16) The compacting apparatus in claim 11 wherein the first guide is attached to the right side of the packing head.

17) The compacting apparatus in claim 11 wherein the first guide is attached to the left side of the packing head.

18) The compacting apparatus in claim 11 wherein the first guide is attached to the left side of the packing head and the second guide is attached to the right side of the packing head.

19) A compacting apparatus comprising:
a packing head, comprising an inside, an outside, a front end, a rear end, a left side and a right side;
a rear cylinder mount, attached near the rear end of the packing head on the outside of the packing head;
a ram comprising a pull bar, the pull bar extending from the inside of the packing head to the outside of the packing head near the front end of the packing head; the pull bar further comprising a cylinder mount on a portion of the pull bar which extends from the packing head;
a first cylinder attached to the rear cylinder mount and attached to the pull bar;
a first guide attached to the packing head and removable from the outside of the packing head;
a first guide attached to the packing head and adjustable from the outside of the packing head.

20) The compacting apparatus of claim 19 wherein the first guide is adjustable from the outside of the packing head using bolts.
